(19) United States
(12) Patent Application Publication
(10) Pub. No.: US 2020/0139871 A1
(43) Pub. Date: May 7, 2020

(54) SMART CUP HOLDER IN THE VEHICLE

(71) Applicant: Continental Automotive Systems, Inc., Auburn Hills, MI (US)

(72) Inventors: David Alberto Urbina Valencia, Zapopan (MX); Carlos Mendez Estrada, Tlajomulco de Zuniga (MX); Juan Carlos Rivera Cruz, Tlajomulco de Zuniga (MX)

(21) Appl. No.: 16/183,004

(22) Filed: Nov. 7, 2018

(51) Int. Cl. B60N 3/10; F25B 21/04

(52) U.S. Cl. CPC B60N 3/104; F25B 2321/0212; F25B 21/04

(57) ABSTRACT

Temperatures of beverages held in a vehicle cup holder are maintained by a Peltier device that is thermally coupled to the beverage holder in a conventional cup holder. A controller operatively coupled to the temperature sensor and the Peltier device receives a temperature signal from the temperature sensor, determines whether the beverage holder has a temperature greater or less than a predetermined value and provides an appropriate voltage to the Peltier device to attempt to hold the temperature.

### BACKGROUND

Most motor vehicles are equipped with drink cup holders. When a user puts a beverage in the cup holder, the beverage temperature will eventually equalize to the temperature inside the vehicle. Cold beverages will eventually get warm. Warm beverages will eventually get cold. A drink holder for a motor vehicle, which is capable of sensing the initial temperature of a beverage and which thereafter attempts to maintain that temperature would be an improvement over the prior art.

### BRIEF DESCRIPTION OF THE FIGURES

FIG. 1 discloses a smart cup holder for a vehicle; and

FIG. 2 depicts steps of a method of automatically maintaining the temperature of an object in a smart cup holder.

### DETAILED DESCRIPTION

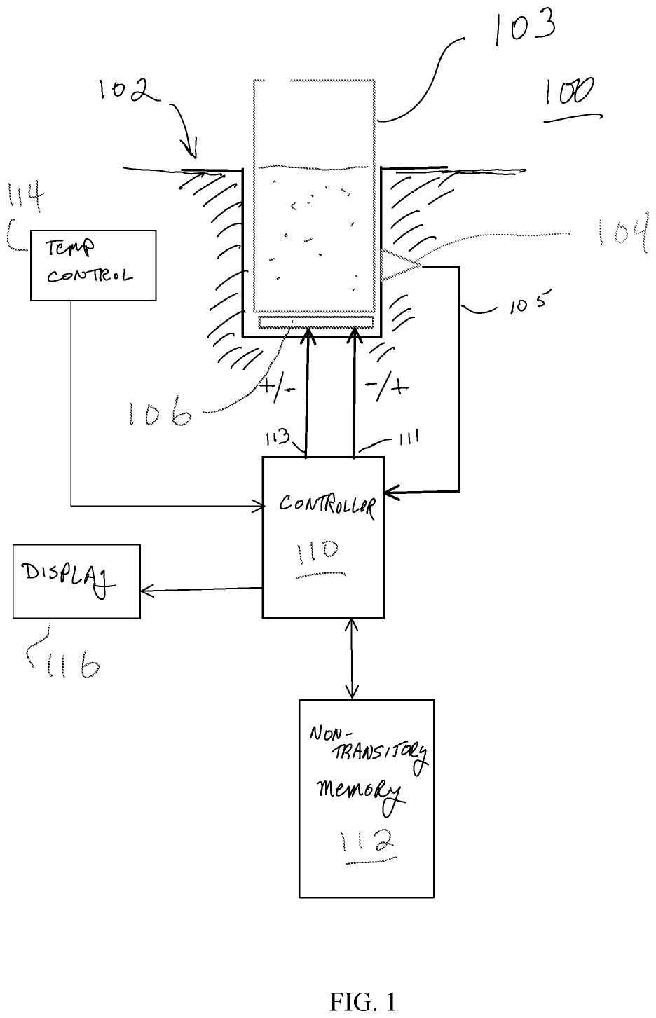

FIG. 1 depicts a smart cup holder 100 for a motor vehicle. A motor vehicle is not shown in the interest of brevity.

The smart cup holder 100 comprises a cup holder 102 configured or “sized, shaped and arranged” to receive beverage containers 103. Examples of beverage containers include a carbonated beverage can, plastic bottle or an insulated cup for hot beverages.

A Peltier device 106 is located inside the cup holder 102. A Peltier device is a well-known thermoelectric cooling and heating device which uses the Peltier effect to create a heat flux between the junction of two different types of materials. A Peltier device can therefore be used for either heating or cooling.

When a Peltier device is operated as a cooling device, a first polarity voltage is applied across the device and as a result, a difference in temperature will build up between the two opposing sides of the device. When used as a heater, the voltage applied to the device is reversed.

The Peltier device 106 in FIG. 1 is electrically connected to a controller 110, preferably embodied as a microcontroller or microprocessor. Most microprocessors and microcontrollers lack circuitry that could provide relatively large amounts of current to the Peltier device 106. Well-known current drivers, omitted from FIG. 1 in the interest of brevity, are therefore used to provide current to the device 106. Two different output terminals 111, 113 of the controller 110 provide voltages to the Peltier device 106, the polarities of which can be reversed by the controller 110 in order to provide voltages to the Peltier device 106 that will drive it as either a heater or cooler.

The controller 110, preferably embodied as a microcontroller or microprocessor, is electrically connected to a temperature sensor 104. The sensor 104 is preferably embodied as an infrared temperature sensor, well-known to those of ordinary skill in the art. It could also be embodied as a thermistor or a transistor, thermally coupled to the interior of the cup holder 102 or beverage container 103.

Put simply, the preferred embodiment temperature sensor 104 “reads” the infrared energy emitted from a beverage container 103 and provides an output signal 105 to the controller 110, which the controller uses to determine or equate to an actual temperature of the beverage container 103 in the cup holder 102.

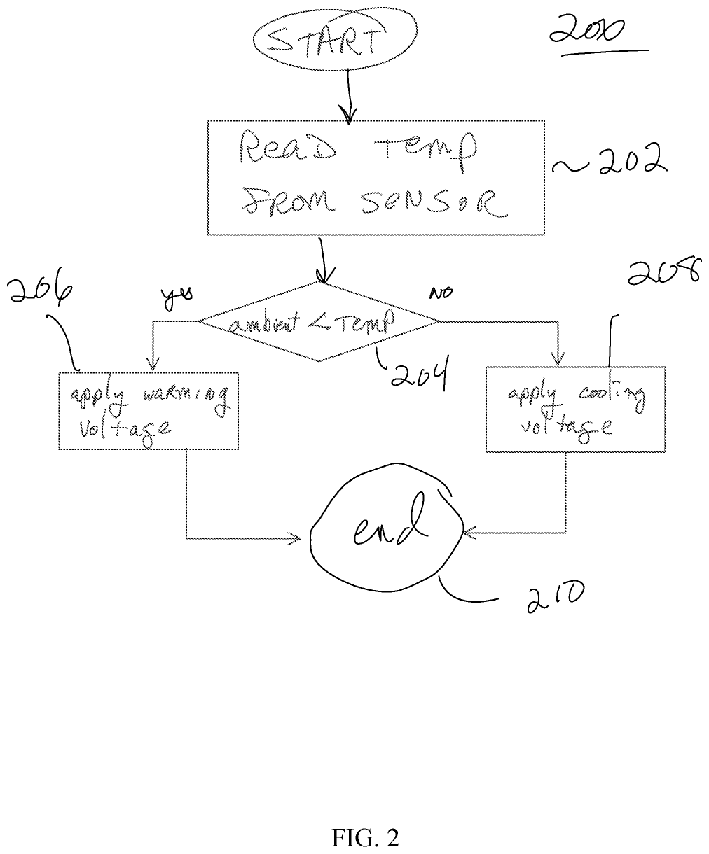

As shown in the figure, the controller 110 is coupled to a non-transitory memory device 112, which stores program instructions for the controller 110. When those instructions are executed, they cause the controller to perform various operations. Those operations include reading input signals from the sensor 104 and generating output signals to the Peltier device 106, which enable automatic detection of the temperature of the beverage container 103 in the cup holder 102 and attempting to maintain that detected temperature. The methodology performed by the controller 110 as it executes those instructions is described below and depicted in FIG. 2.

Still referring to FIG. 1, an optional temperature control user interface device 114, well known to those of ordinary skill, is connected to an input of the controller 110. Signals from that temperature control device 114 allow a user to specify a desired temperature to attempted by the Peltier device.

An optional display device 116, well known to those of ordinary skill, is also coupled to the controller 110, provides an output signal, preferably digital, showing the temperature of the object in the cup holder as measured by the temperature sensor 104 and as read by the control 110.

Referring now to FIG. 2, steps of a method for automatically maintaining the temperature of an object in the vehicle cup holder are depicted. In a first step 202 the controller reads the temperature of an object in the cup holder. At step 204, a determination is made whether the temperature of the object in the cup holder is greater than the ambient temperature inside the vehicle. If the temperature of that object is greater than ambient temperature, the process proceeds to step 206 where the controller applies a voltage to the Peltier device which causes the face in contact with the cup holder to heat up. On the other hand, if the temperature of the device in the cup holder is not greater than ambient, a presumption is made that the object is cold and the process proceeds to step 208 where the polarity of the voltage applied to the Peltier device is reversed, causing the device to attempt to cool the object in the cup holder. At step 210, the temperature of the sensor is read again. The previous steps are repeated until the temperature of the object inside the cup reaches the ambient temperature, at which point the process ends based on an assumption that the contents of the object in the cup holder have been consumed or the object in the cup holder has been removed. In either case, temperature maintenance of the object is no longer required.

In an alternate embodiment, the method depicted in FIG. 2 allows a user to set a desired temperature using the temperature control 114 coupled to the controller 110.

The foregoing description is for illustration purposes only. The true scope of the invention is set forth in the following claims.

What is claimed is:

1. A smart cup holder for a vehicle, the smart cup holder comprising:
a cup holder;
a temperature sensor configured to determine the temperature of an object in the cup holder and configured to provide a temperature signal representative of said temperature of said object in the cup holder;
a Peltier device in the cup holder;
a controller operatively coupled to the temperature sensor and the Peltier device, the controller being configured to:
receive the temperature signal from the temperature sensor;
determine from the temperature signal whether the object in the cup holder has a temperature greater or less than a predetermined value; and
apply a first predetermined voltage to the Peltier device responsive to a determination that the object's temperature is greater than the predetermined value; and
apply a second and different predetermined voltage to the Peltier device responsive to a determination that the object's temperature is less than the predetermined value.

2. The smart cup holder of claim 1, wherein the predetermined value is specified by a user of the smart cup.

3. The smart cup holder of claim 1, wherein the controller is additionally configured to continue to apply one of the first and second voltages to the Peltier device for a predetermined time, at the expiration of which voltage applied to the Peltier device is shut off.

4. The smart cup holder of claim 1, wherein the first voltage provided to the Peltier device causes the Peltier device to provide heat energy to the cup holder and wherein the second voltage provided to the Peltier device causes the Peltier device to absorb heat energy from the cup holder.

5. The smart cup holder of claim 1, wherein the temperature sensor is an infrared sensor.

6. The smart cup holder of claim 1, wherein the temperature sensor is the Peltier device, wherein the Peltier device generates a first output voltage if the object is warm and a second and different output voltage if the object is cool.

7. A method of automatically maintaining the temperature of an object in a vehicle cup holder, the method comprising:
determining the temperature of the object;
if the temperature of the object is less than a predetermined threshold temperature, applying a first voltage to the Peltier device, which causes a first predetermined side of the Peltier device to cool; and
if the temperature of the object is greater than a predetermined threshold temperature, applying a second voltage to the Peltier device, which causes the first predetermined side of the Peltier device to warm.

8. The method of claim 7, further comprising the step of:
display a temperature of the cup on an in-vehicle display device.
